(19) United States
(12) Patent Application Publication
(10) Pub. No.: US 2026/0093252 A1
(43) Pub. Date: Apr. 2, 2026

(54) PROJECT INTEGRATION EVALUATION AND REPORTING SYSTEM AND METHOD

(71) Applicants: AT&T Intellectual Property I, L.P., Atlanta, GA (US); AT&T Mobility Il LLC, Atlanta, GA (US)

(72) Inventors: Joseph Maniaci, St. Paul, MN (US); Lee Breslau, Basking Ridge, NJ (US); Adrian Pescaru, Mouount Prospect, IL (US); Ashiwan Sivakumar, Hillsborough, NJ (US); Giritharan Rana, Basking Ridge, NJ (US); Shomik Pathak, Richardson, TX (US)

(73) Assignees: AT&T Intellectual Property I, L.P., Atlanta, GA (US); AT&T Mobility Il LLC, Atlanta, GA (US)

(21) Appl. No.: 18/901,188

(22) Filed: Sep. 30, 2024

(51) Int. Cl. G05B 23/02

(52) U.S. Cl. CPC G05B 23/0272; G05B 23/0235; G05B 2223/06

(57) ABSTRACT

Aspects of the subject disclosure may include, for example, determining a site integration issue regarding integration of equipment into a remote site based on a group of installation activity validation results obtained from site integration equipment of a site integrator regarding integration of equipment into a remote site of a geographically dispersed operational system. A remediation action is determined regarding the site integration issue for the remote site and an indication of the remediation action is provided to the site integrator, wherein implementation of the remediation action at the remote site results in a group of updated installation activity validation results. The group of installation activity validation results, the indication of the remediation action and the group of updated installation activity validation results are incorporated into a report. Other embodiments are disclosed.

### FIELD OF THE DISCLOSURE

The subject disclosure relates to a project integration evaluation and reporting system and method.

### BACKGROUND

Large complex systems, such as communication networks, require updates and enhancements from time to time. For example, wireless mobile systems may require updates and/or adjustments to radio access network (RAN) systems. Such updates and/or adjustments may be directed towards adding a new feature, such as a new feature described in the emerging wireless protocols. Alternatively, or in addition, the updates and/or adjustments may be directed to realigning antennas to adjust sector coverage, adding spectrum to build out services, and so on.

For situations in which an existing system is operational, it is important to streamline implementation of any updates and/or adjustments to minimize any interference to ongoing operations. In at least some situations, a site integrator may perform activities supporting the addition and/or readjustment of site equipment in such a manner so as not to interfere with ongoing operations. It is common in such instances to identify a list of pre-check activities that may be performed before launching the new and/or adjusted equipment into the existing system.

It is not uncommon in existing complex systems to encounter issues during the pre-check activities that must be addressed before launch. In such instances, varying degrees of communications and status updates may be required among and between participating entities, such as site integrators, engineering and/or project management.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a project integration evaluation and reporting system functioning within the communication network of FIG. 1 in accordance with various aspects described herein.

FIG. 2B depicts an illustrative embodiment of a project integration evaluation and reporting process in accordance with various aspects described herein.

FIG. 2C is a block diagram illustrating an example, non-limiting embodiment of a project integration evaluation and reporting processor functioning within the communication network of FIG. 1 and within the project integration evaluation and reporting system of FIG. 2A in accordance with various aspects described herein.

FIG. 2D depicts an illustrative embodiment of a project integration evaluation report in accordance with various aspects described herein.

FIG. 2E is a block diagram illustrating an example, non-limiting embodiment of a project integration evaluation and reporting system functioning within the communication network of FIG. 1 in accordance with various aspects described herein.

FIG. 2F depicts an illustrative embodiment of a project integration evaluation and reporting process in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for determining a site integration issue regarding integration of equipment into a remote site of an operational system, such as a communication network, identifying a remediation action and providing it to the site integrator to obtain updated installation activity validation results, which are incorporated into a remotely accessible report that facilitates tracking of issues, and remedies along with related communications in an efficient and organized manner. Other embodiments are described in the subject disclosure.

One or more aspects of the subject disclosure include a process that includes receiving, by a processing system including a processor, a group of installation activity validation results obtained from site integration equipment of a site integrator regarding integration of equipment into a remote site of a geographically dispersed operational system. The process further includes identifying, by the processing system, a site integration issue regarding integration of the equipment into the remote site based on the group of installation activity validation results. The process further includes transmitting, by the processing system and responsive to the identifying the site integration issue, a first communication to equipment of an engineer reporting the site integration issue for the remote site, and receiving, by the processing system, a second communication from the equipment of the engineer identifying remediation action regarding the site integration issue for the remote site. The process further includes receiving, by the processing system, a third communication that includes a group of updated installation activity validation results reflecting implementation of the remediation action at the remote site. The process further includes organizing, by the processing system and within a report, the first, second and third communications in association with an indication of at least one of the remote site, the site integrator or the engineer, to obtain organized communications, wherein the report is remotely accessible.

One or more aspects of the subject disclosure include a non-transitory, machine-readable medium including executable instructions that, when executed by a processing system including a processor, facilitate performance of operations. The operations include obtaining a group of installation activity validation results obtained from site integration equipment of a site integrator regarding integration of equipment into a remote site of a geographically dispersed operational system. The operations further include determining a site integration issue regarding integration of the equipment into the remote site based on the group of installation activity validation results. The operations further include sending, responsive to the determining the site integration issue, a first communication to equipment of an engineer reporting the site integration issue for the remote site. The operations further include obtaining a second communication from the equipment of the engineer identifying a remediation action regarding the site integration issue for the remote site. The operations further include receiving a third communication from the equipment of the site integrator, wherein the third communication includes a group of updated installation activity validation results obtained responsive to implementation of the remediation action at the remote site. The operations further include organizing within a report the first, second and third communications in association with an indication of at least one of the remote site, the site integrator or the engineer, to obtain organized communications, wherein the report is remotely accessible.

One or more aspects of the subject disclosure include a system including a processing system including a processor and a memory that stores executable instructions. The executable instructions, when executed by the processing system, facilitate performance of operations that include determining a site integration issue regarding integration of equipment into a remote site based on a group of installation activity validation results obtained from site integration equipment of a site integrator regarding integration of equipment into a remote site of a geographically dispersed operational system. The operations further include determining a remediation action regarding the site integration issue for the remote site. The operations further include obtaining a group of updated installation activity validation results responsive to implementation of the remediation action at the remote site. The operations further include organizing within a report the group of installation activity validation results, the indication of the remediation action and the group of updated installation activity validation results.

New RAN (Radio Access Network) elements are added to the network on a daily basis in large telecommunications companies. There is an inefficiency in the current acceptance process because of the amount of email communication that is required between vendor, project manager, and market engineer. If there is an issue with site acceptance, the market engineer may report to the project manager who then reports to the integration vendor that there is a problem. The problem is then corrected, and subsequent communications, e.g., emails are sent back to the project manager and to the market engineer. This type of reporting may result in large number of communications, which may tend to cloud the underlying issue and tend to reduce efficiencies.

A process change according to the PIER techniques disclosed herein results in the PIER process being put much sooner in the process of a project integration, such as a new carrier launch at an existing mobile communications site. It stands to reason that all projects, e.g., site integrations, be performed with better accuracy. At least one approach is to push remediation information directly to the responsible vendor performing the integration work. For example, the PIER techniques disclosed herein allow for on demand precheck analysis for a LTE,5G, or any future generation site. The PIER techniques reduce and/or otherwise allow for a single point of communication on sites to be seen between vendor, project manager, and engineer. With further enhancements of machine learning (ML) and/or artificial intelligence (AI), the PIER techniques will be able to detect any trends or patterns in precheck related issues and direct product improvement more efficiently.

The PIER techniques provide an interface that allows vendors to run prechecks or acceptance criteria on demand for any site in a telecommunications network. This can be in the form of an application programming interface (API) and/or a graphical user interface (GUI). The PIER approach can trigger a larger number of prechecks, e.g., 40 prechecks, with multiple checks per precheck within the following categories: alarms, Atoll, design vs. implementation audit, eNB software, ENMT, hardware Installation check, PACE milestone, parameters, and project dependency. These are a comprehensive view into the health and quality of a newly integrated LTE, 5G, or any future generation site or carrier. If there are any issues or comments with a precheck result, the integration vendor may enter any notes on the project and those notes can be seen by the project manager and market engineer.

Not only does an integration vendor get the expectations directly from the tool, but they can also see if there are any prechecks failing and are notified on common steps for mitigation. This clears up ambiguity in expectations and reduces the time between a vendor learning about any precheck issues and their ability to resolve them. This also requires less time and effort from the system or network operator perspective, which in turn saves money. There is an increased likelihood of a cleaner site which corresponds to better customer perception of the network. There is a single point of information on a project or site in PIER reducing the amount of email communications. Prechecks can be run on demand by the users which gives near real time information. PIER will have the ability to find patterns and trends in the comments and data using AI/ML that would alert the team to any potential issues with the various prechecks.

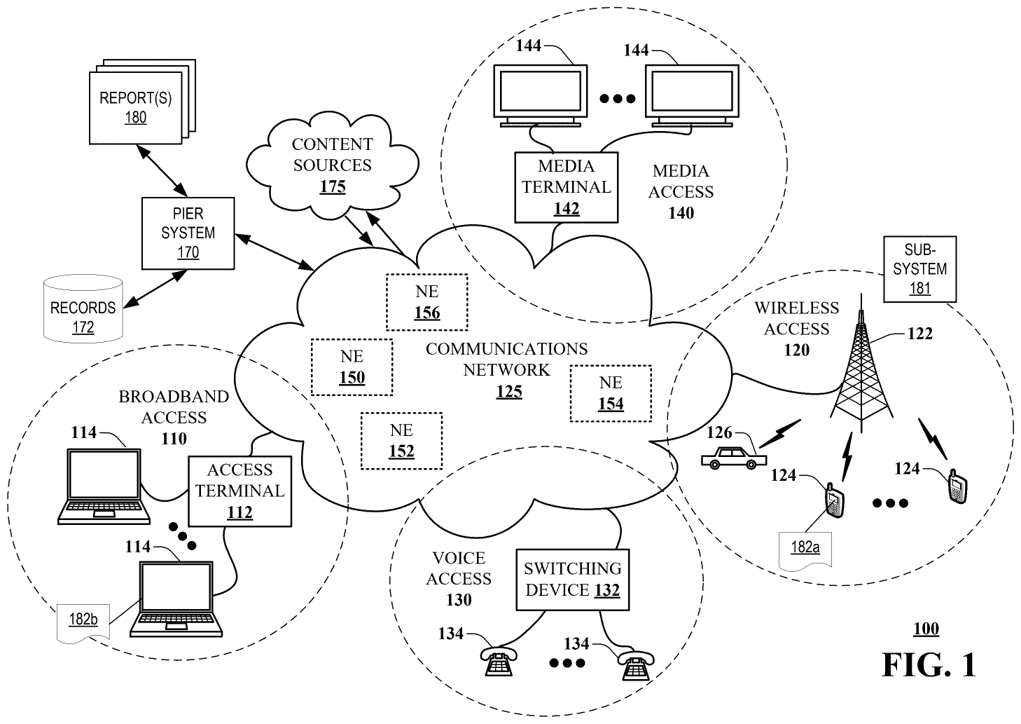

Referring now to FIG. 1, a block diagram is shown illustrating an example, non-limiting embodiment of a communication network 100 in accordance with various aspects described herein. For example, communication network 100 can facilitate in whole or in part determination of a site integration issue regarding integration of equipment into a remote site of an operational system, identification of a remediation action, which is sent to the site integrator to obtain updated installation activity validation results, which are incorporated into a remotely accessible report that facilitates tracking of issues, and remedies along with related communications in an efficient and organized manner. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc., for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc., can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

The communications network 100 includes project integration evaluation and reporting (PIER) system 170 configured to generate reports 180 and facilitate expedited and organized communication between site integration participants related to integration of equipment, e.g., the example subsystem 181, into a remote communications site.

According to the illustrative embodiment, the PIER system 170 may be in communication with a storage device or system 172, which may be used to store the reports 180, communications, site specific information, e.g., site acceptance criteria, precheck tasks, and the like. In at least some embodiments, one or more of the mobile devices 124 and the data terminals 114 may be configured with an application program and/or portal to access a user interface 182a, 182b. The user interface 182a, 182b, generally 182, facilitates organization and reporting of activities related to integration of the subsystem 181.

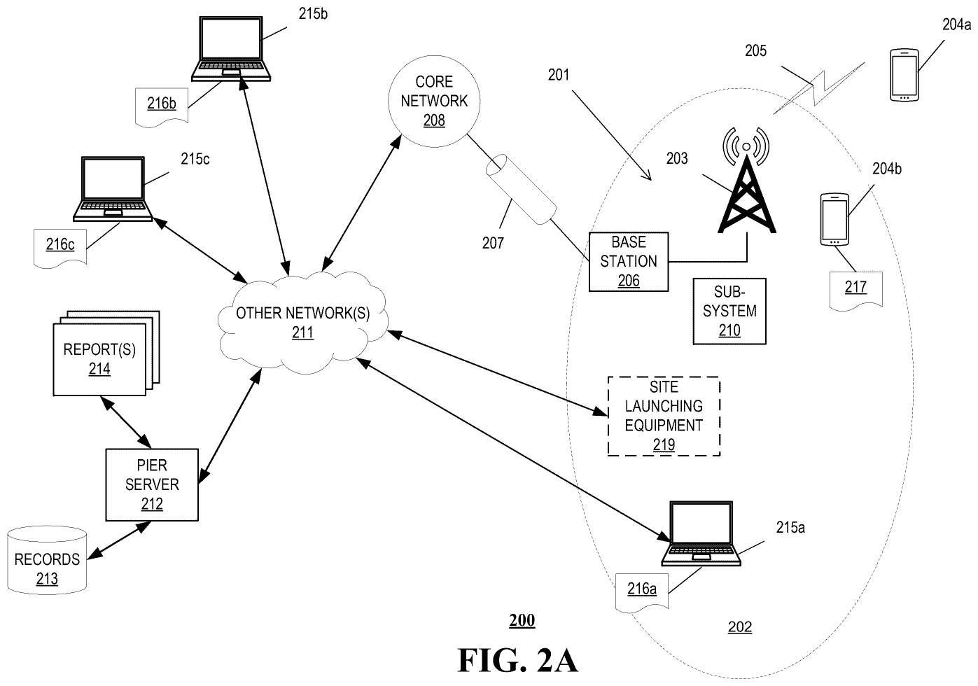

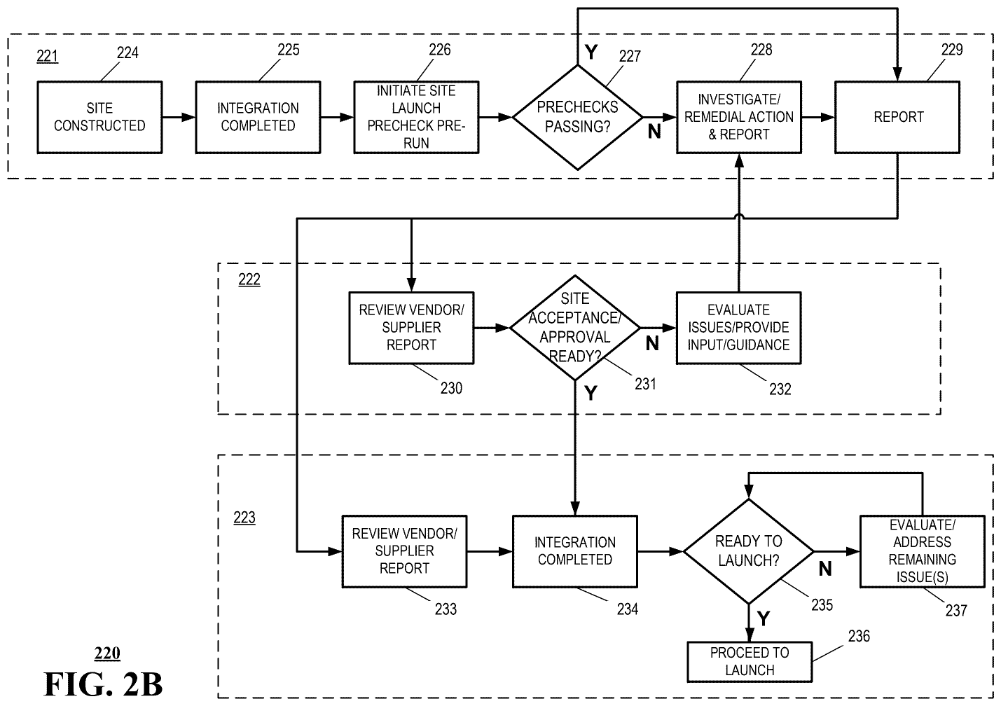

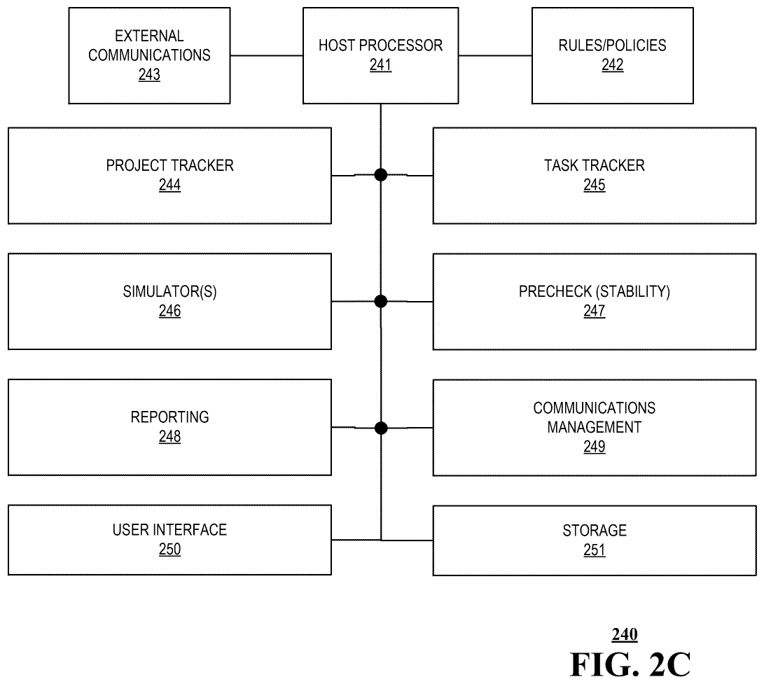

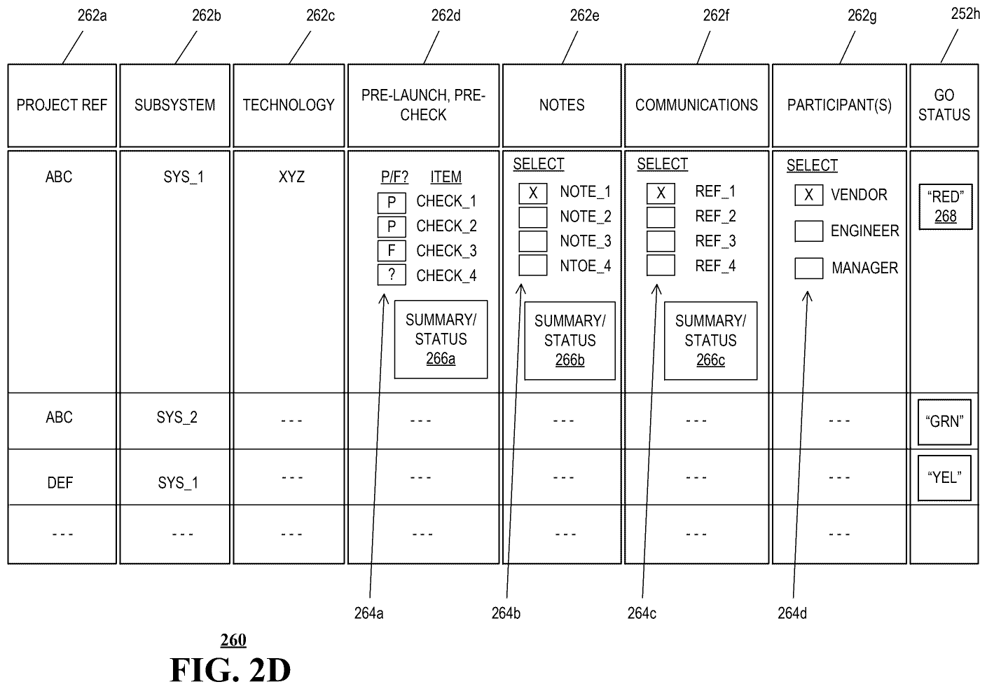

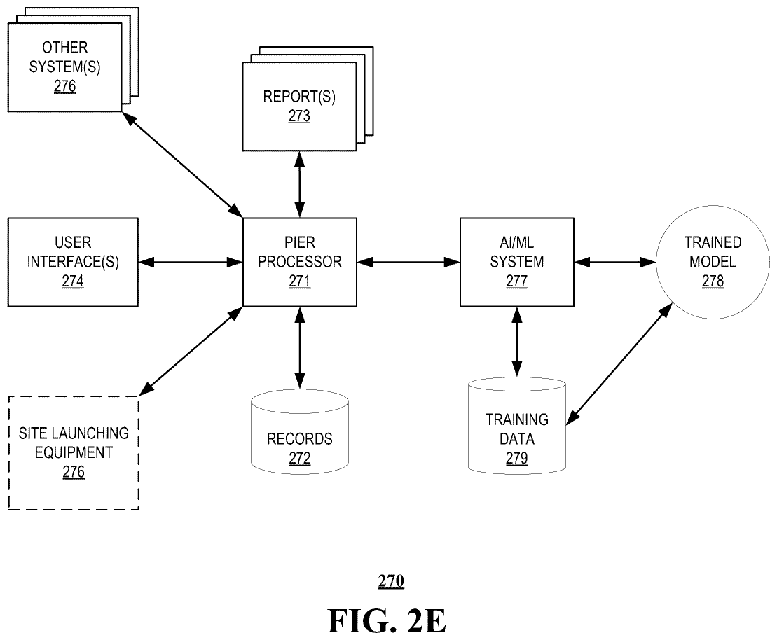

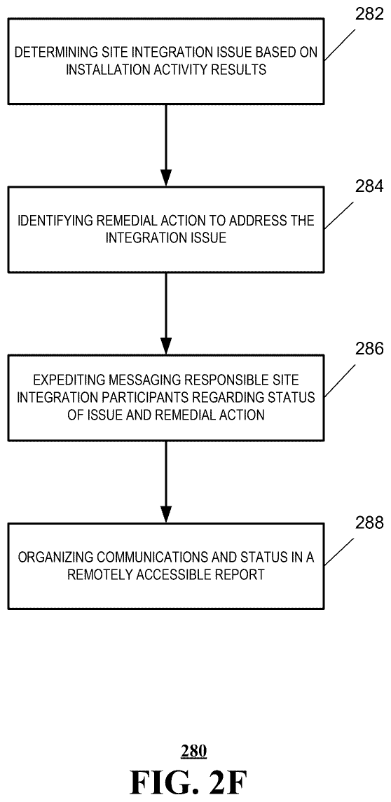

FIG. 2A is a block diagram illustrating an example, non-limiting embodiment of a project integration evaluation and reporting (PIER) system 200 functioning within the communication network 100 of FIG. 1 in accordance with various aspects described herein. According to the illustrative example, the project relates to incorporating and/or reconfiguring a subsystem 210 into one or more existing operational systems. For example, incorporation of the subsystem 210 into the existing system can add, modify and/or otherwise improve functionality of the existing. In at least some situations, it preferable to incorporate the subsystem 210 with as little, to no, interference as possible to operations of the existing system. To this end, installation of the subsystem 210 may be accomplished without interfering with operations of the existing system. Any new features and/or performance enhancements realized by the new subsystem 210 will be provided after the installed subsystem 210 is activated, brought online and/or otherwise launched.

Based on complexities of existing systems and/or the new subsystems 210, as well as sensitivities of ongoing operations to interruptions, it is prudent to perform one or more inspections, evaluations and/or tests, referred to herein generally as pre-launch checks, before launching operation of the new subsystem. Such pre-launch checks can be identified, selected and/or otherwise designed to provide a high level of assurance that a launching if the subsystem 210 will be successful, and at the very least, will not hinder ongoing operations of the existing system any more than would be absolutely necessary.

Continuing with the illustrative example, an existing system is represented by a mobile communication station 201. The mobile communication station 201 is geographically situated to provide wireless service to subscribers within a predetermined region, e.g., one or more sectors, as determined by a mobile network operator. The example mobile communication station 201 includes a radio frequency (RF) portion 203 that includes one or more antennas, and a baseband portion, e.g., a bast station 206, configured to support wireless services via licensed and/or unlicensed spectrum 205 downlinks and/or uplinks via the RF portion 203. The base station 206, in turn, may be in further communication with a mobility core network 208 via a backhaul communications link 207. The mobility core network 208 may function according to one or more different mobile technologies, e.g., any of the example wireless technologies disclosed herein, including 4G, LTE, NR, 5G and beyond, as may be implemented according to corresponding protocols, e.g., 3GPP protocols. For example, the mobile core network 208 may facilitate billing, handovers between different mobile communication stations 201, roaming capabilities, emergency 911 features, and so on. In at least some embodiments, the mobility core network 208 is in further communication with one or more other networks 211, e.g., the public internet, the World Wide Web, a switched communication service, a private network, and the like.

In at least some embodiments, and without limitation, the subsystem 210 may provide an enhanced functionality to an existing system, e.g., adding and/or updating a technology and/or feature available under a serviced technology, such as LTE, NR and/or 5G. Alternatively, or in addition, the subsystem 210 may provide an additional RF subsystem, e.g., an additional antenna and/or a replacement of an existing antenna subsystem, a new carrier, and/or other equipment as may operate in one or more of the RF portion 203, the base station 206, the backhaul 207, the core network 208 and so on.

It is understood that integration of a new subsystem 210 to the existing mobile communication station 201 will require that a variety of functions be carried out to ensure a smooth integration and launch. Generally speaking, these functions can be distinguished according to a design and/or analysis function, an equipment procurement, installation and test function, and a management function. It is possible that in some instances different entities will be responsible for the different functions. Alternatively, or in addition, one or more entitles may provide more than one function and possibly all of the different functions. Even if this were the case, it is advantageous to treat the functions as distinguishable to facilitate overall design, integration, test and management in an organized and effective manner.

According to the illustrative embodiment, a vendor entity may be responsible for provisioning, installation and testing associated with the new subsystem 210. In at least some instances, the installation may require site preparation work at a remote facility 202, e.g., a cell site. Without restriction, site preparation may include a substantial facilities effort, e.g., constructing, remodeling and/or renovation of buildings, environmental enclosures, equipment towers. Alternatively, or in addition, facilities activity may include provision of equipment racks, prime power, cooling, cabling, lighting, and so on. To the extent new equipment is required, the vendor may be tasked with obtaining any equipment that may be necessary. It is understood that in at least some scenarios, the new subsystem 210 may be provided by utilizing available equipment, e.g., spare capacity on existing equipment and/or a reconfiguration or re-tasking of existing equipment. In at least some instances, the vendor will be responsible for installation and/or testing at a remote location and/or facility, such as the example mobile communication station 201.

According to the example scenario, it would be beneficial for the vendor to have access to the project integration evaluation and reporting (PIER) system 212, especially while personnel are on-site at the remote facility 202. Such remote access would allow the vendor's on-site team to access information, to provide reporting updates and/or to otherwise coordinate communications as may be advantageous to facilitate integration of the new subsystem 210. For example, if an issue is encountered as may be determined according to a failed pre-check procedure, the on-site team may solicit input as may be advantageous to identify a cause and/or solution to the issue while the on-site team is at the facility 202.

The example PIER system 200 includes at least sone PIER server 212 that has been adapted and/or otherwise configured to provide one or more functions, services and/or capabilities to one or more entities and/or participants to facilitate projects that adapt, enhance and/or otherwise modify existing operational systems, such as the example mobile communication station 201. For example, the PIER server 212 may provide functions, services and/or capabilities to facilitate a tracking of status of the subsystem integration project, a dissemination of status information and/or communications among and between the various participants. To that end, it is envisioned that each of the participants, at least each of the different functions, will have access to one or more of the functions, services and/or capabilities of the PIER server 212.

By way of example and considering three functional entities are involved with a project to integrate the new subsystem 210 into the existing mobile communication station 201, the example PIER system 200 includes a respective access portal for each function. The access portals may be provided by way of a dedicated terminal, an application program hosted on an existing terminal and/or a mobile application as may be downloaded to a mobile communication device. In this instance, a vendor terminal 215a may be provided at the remote facility 202. The vendor terminal 215a may include a PIER application program 216a configured to facilitate interactions between vendor personnel, the PIER server 212, and other functional entities as may be necessary. Alternatively, or in addition, mobile user equipment 204a, 204b, generally 204, e.g., of on-site vendor personal, may be configured with a PIER application program 217 configured to facilitate interactions between vendor personnel, the PIER server 212 and other functional entities as may be necessary.

Further according to the illustrative example, an engineering and/or analyst terminal 215b may be provided at a convenient location and including a PIER application program 216b configured to facilitate interactions between engineering and/or analyst personnel, the PIER server 212, and other functional entities as may be necessary. Likewise, a project management and/or oversight terminal 215c may be provided at a convenient location and including a PIER application program 216c configured to facilitate interactions between project management and/or oversight personnel, the PIER server 212, and other functional entities as may be necessary.

In at least some embodiments, the PIER server 212 may be accessible via a network, such as the core mobility network 208 and/or one or more of the example other networks 211. In at least some embodiments, communications between and among the PIER server 212, the vendor terminal 215a, the engineering and/or analyst terminal 215b, the project management and/or oversight terminal 215c and/or any mobile user equipment 204 as may be utilized by one or more of the participants may be secured. In at least some embodiments, security is provided at least in part by one or more virtual private networks (VPNs). Alternatively, or in addition, access to one or more of the PIER server 212, PIER reports 214 as may be generated by and/or otherwise updated via the PIER server 212, related data, e.g., stored records 213 and related communications may include security features. By way of example, security features may include password protection, encryption, biometric data, multi-factor authentication, and the like.

In at least some embodiments, the remote site 202 may include site launching service and/or equipment 219 (shown in phantom). Without limitation, site-launching equipment may include test equipment temporarily provided by the vendor. Alternatively, or in addition, the site-launching equipment may include equipment that may be used to provide configuration and/or reconfiguration of equipment as may be necessary to accomplish integration of the subsystem 210. It is understood that the site-launching equipment may be located at the remote facility, and/or at some other location, e.g., an operation center, as maybe accessible via a network, e.g., one or more of the other networks 211.

FIG. 2B depicts an illustrative embodiment of a project integration evaluation and reporting (PIER) process 220 in accordance with various aspects described herein. According to the illustrative example, the PIER process 220 can be grouped into different segments, e.g., according to responsible functional entities. According to a previous example, three functional entities may be distinguished as participants in an integration project, e.g., a vendor, an engineer and/or analyst, and a project manager. It is understood that different functional entities may be identified according to different integration projects, e.g., a compliance function, a legal function, a regulatory function and so on. It is also envisioned, that in at least some embodiments, one or more of the different functions may be performed by the same entity, who may be responsible for more than one of the different functions.

The example PIER process 220 includes a vendor functional segment 221, an engineering and/or analyst function segment 222 and a project management and/or oversight functional segment 223. The vendor functional segment 221 includes site construction at 224. Site construction may include any physical site preparation at a physical location, such as construction, renovation, repurposing of existing on-site facilities. Alternatively, or in addition, site construction may include construction and/or configuration activities at more than one location. For example, an addition of a new subsystem to an existing cell site, e.g., a new base station, may require site preparation to accommodate the new base station and/or new RF equipment and/or antenna(s) as may be necessary. Alternatively, or in addition, the construction may include related activities at other locations, e.g., reconfiguration of a backhaul link as may be necessary by the addition of the new base station and/or a reconfiguration and/or provisioning of equipment at a mobility core network to accommodate the new base station. In at least some instances, construction may include physical processes. Alternatively, or in addition, construction may include other processes, such as updating software, reconfiguring existing equipment and/or software applications, and so on.

At some point in an integration project, the integration may be completed at 225. Completion may be determined according to the nature of the project. Generally speaking, integration completed may signify that construction has been completed and that a new subsystem is ready for a pre-launch evaluation. According to the example PIER process 220, a pre-launch evaluation may be performed at 226. The pre-launch evaluation may include one or more precheck procedures. Without limitation, the procedures may include inspection of construction activities, inspection of construction data, e.g., construction testing, including functional testing of the new subsystem as may have been performed during construction and in preparation for the pre-launch evaluation. Alternatively, or in addition, the pre-launch evaluation 226 may include testing according to precheck procedures.

According to the illustrative PIER process 220, a determination may be made at 227 as to whether any precheck procedures are passing. In at least some embodiments, the determination may be made as precheck procedure data and/or results becomes available. Alternatively, or in addition, the determination may be made upon completion of a subset and/or all of the precheck procedures to be performed for the particular integration project. In at least some embodiments, the precheck procedures may be grouped, e.g., physical checks, operational checks, quality checks, and the like. In such instances, the determination at 227 may be performed upon completion of a subgroup of the precheck procedures.

To the extent the precheck procedures indicating passing results, one or more pre-check reports may be created and/or otherwise updated at 229 to reflect a passing status of the precheck procedures. To the extent that the precheck procedures did not result in passing results, in investigation and/or identification of remedial action may be identified, performed and/or otherwise reported at 228. In either instance, the report may be shared with one or more of the other functional entities, e.g., by the engineer and/or analysis and/or by the project manager and/or oversight entity.

The engineer and/or analyst may review the vendor report at 230. In at least some instances, the report is prepared by the PIER server 212, e.g., automatically upon detection and/or entry of precheck procedure results. Alternatively, or in addition, the report is prepared by vendor personnel and entered into and/or otherwise made accessible via the PIER server 212. In at least some embodiments, the PIER server 212 may provide update notifications and/or alarms to one or more of the functional entities. In at least some embodiments, the notifications may include details, e.g., an identification of which precheck procedure(s) are being reported, an indication of the results, and any other related information as may be helpful in furthering integration of the subsystem.

The engineer and/or analysis may determine at 231 whether the site is ready for launch. Such a determination may relate to acceptance criteria, e.g., a grade, a rating and/or a passing indication of at least some if not all of the precheck procedures. It is understood that some precheck procedures may be critical in nature, such that acceptance may not be possible without an indication of a suitably passing result. Alternatively, or in addition, at least some of the precheck procedures may be less critical, such that acceptance may be approved, e.g., with caveats that certain less critical items remain to be addressed. In at least some embodiments, the determination is based upon an inspection of the vendor report as accessed via the PIER server 212.

To the extent it is determined at 231 that site acceptance approval is not ready, an evaluation of any related issue(s) may be performed at 232. In at least some embodiments, the evaluation of issues may result in further inquiries to be addressed by the engineering function and/or any combination of the other functions. In such instances, the inquiries may be directed to the appropriate entities either directly via direct communications and/or via communications managed by the PIER server 212. According to the illustrative example, results of the evaluation of issues at 232, possibly including input, guidance and/or suggestions may be provided to the vendor function, permitting further investigation, remedial action(s) and/or reporting as may be necessary at 228.

In at least some embodiments in which direct communications are used, at least a copy of the direction communications may be submitted to the PIER server 212, e.g., to be captured and preserved and/or otherwise linked. For example, the PIER server 212 may maintain logs that track issues and associate related inquiries, related communications, status information, e.g., a status timeline, a current status, and possibly predictions of resolution activity.

To the extent it is determined at 231 that site acceptance approval is ready, an indication may be provided to one or more of the functions. According to the illustrative example, a notification is provided to the project management or oversight function. The project management and/or oversight function may, in turn, determine and/or otherwise declare that integration has been completed. In at least some embodiments a determination that integration has been completed occurs at 234 based upon one or more of input from another function, such as an indication from the engineer and/or analyst function that site acceptance is ready for approval alone or in combination with a separate review of a vender supplied report at 233. In at least some embodiments, the vendor report and/or the indication from the engineer and/or analyst function may be shared, provided and/or otherwise managed through the PIER server 212.

Having determined and/or otherwise declared at 234 that integration has been completed, the project management and/or analyst function may determine at 235 as to whether the integrated subsystem is ready to launch. This may depend on one or more contributing factors, such as a condition of the existing operational system into which the subsystem is being integrated, an availability of resources, including launch supporting personnel, budget, schedule, and so on. To the extent it is determined at 235 that the integrated subsystem is ready to launch the example PIER process 220 may proceed to launch at 236. An example launch of radio spectrum is described in U.S. Pub. App. No. 2022/0264361, U.S. patent application Ser. No. 17/286,286, filed Feb. 26, 2021, entitled “Launching Radio Spectrum Resources into a Fifth Generation (5G) Network or Other Next Generation Network”, and incorporated herein by reference in its entirety.

However, to the extent it is determined at 235 that the subsystem is not ready to launch, an evaluation and/or identification is performed at 237, e.g., to address any remaining issues. It is understood that the evaluation of remaining issues may involve participation of one or more of the other entities, e.g., repeating one or more of any of the preceding actions as may be necessary. In at least some embodiments the evaluation, status and/or tracking of remaining issues may be performed in whole or in party according to the PIER server 212. For example, the PIER server 212 may notify other functions of the issues to be addressed, capture related communications between functions throughout the process 220 until a determination at 235 as to whether the new subsystem is ready to launch is repeated, resulting a determination to proceed with a launch at 236.

FIG. 2C is a block diagram illustrating an example, non-limiting embodiment of a project integration evaluation and reporting (PIER) processor 240 functioning within the communication network 100 of FIG. 1 and within the PIER system 200 of FIG. 2A in accordance with various aspects described herein. In at least some embodiments, the PIER processor 240 includes a host processor 241 adapted and/or otherwise configured to orchestrate, integrate, facilitate and/or otherwise enable any combination of the various example PIER processes, procedures and/or functions disclosed herein.

In at least some embodiments, the PIER processor 240 includes any combination of one or more of a project tracking module 244, a task tracking module 245, one or more simulator(s) 246, a precheck and/or integration stability module 247, a reporting module 248, a communications management module 249, a storage module 248. In at least some embodiments, the PIER processor 240 also includes a communications module 243 and in at least some configurations, a rules and/or policy module 242.

In at least some embodiments, the project tracking module 244 is configured to identify and/or otherwise distinguish projects to facilitate operation of the PIER processor 240 across multiple projects. It is envisioned that in at least some embodiments a project refers to a particular upgrade, enhancement and/or integration of new equipment into an existing operational system. Alternatively, or in addition, the PIER processor 240 may be used to build out an entirely new system, which may be integrated into another system, e.g., a communication network, and/or as a standalone system. Projects may be tracked and/or otherwise distinguished by any distinguishable feature. Such features may include a codename associated with a project, a geographic location, address, or other location indicator associated with the project, a system description related to the project, technology associated with the project, a commercial application associated with the project, an owner and/or operator of the project, a vendor associated with the project, and so on. In at least some embodiments, the project tracking module 244 may use the project identifier to organize project activities, such as related project tasks, project reports, project participants, project owners, project cost indicators, project status indicators, project related communications, and so on.

In at least some embodiments, the task tracking module 245 is configured to identify and/or otherwise distinguish tasks related to a particular project and/or otherwise managed by the PIER processor 240. It is envisioned that in at least some embodiments a task and/or group of related tasks, e.g., a task list and/or task progression, refers to a particular system and/or subsystem, a particular upgrade, enhancement and/or integration of new equipment into an existing operational system. Tasks may be tracked and/or otherwise distinguished by any distinguishable feature. Such features may include a codename associated with a task, a category associated with the task, a subtask and/or task description related to the task, a technology associated with the task, an owner and/or operator of the task, a vendor associated with the task, and so on. In at least some embodiments, the task tracking module 244 may use a task identifier to indicate a status of tasks required to complete integration and/or pre-check evaluations that occur before pre-launch of the new subsystem and/or enhanced system. In at least some embodiments, the task tracker 245 organizes detailed and/or summary task status information. For example, a task status may be indicated by a color, e.g., red, yellow, green reflecting a current status of task completion. The task status may be reported individually per task and/or according to some combinations of tasks. In at least some embodiments, a user may configure a task tracking and/or task status reporting, e.g., according to a user preference and/or a project requirement.

Generally speaking, tasks may relate to any aspect of installation, integration, test and acceptance of a new subsystem, modified existing system and/or new system.

Tasks may include, without limitation, engineering and design tasks, site preparation tasks, e.g., construction tasks, equipment procurement tasks, equipment installation tasks, equipment testing tasks, regulatory evaluation tasks, operational performance tasks, safety related tasks, and so on. The tasks may cover engineering activities, installation activities, project oversight activities, e.g., project milestones, and so on.

In at least some embodiments, the one or more simulator(s) 246 may be integrated into the PIER processor 240. The simulators may include executable instructions that operate according to user input and/or information obtained from the system to simulate one or more aspects of a particular project and/or task related to a project. In at least some embodiments, at least some of the simulator(s) 246 may be hosted on other systems. In such instances, the PIER processor 240 may provide an interface, e.g., to interact with a remote simulator to initiate simulations, to obtain simulation results and/or to present and/or otherwise analyze simulation results. By way of example, the simulation module 246 may provide access to wireless design and optimization platform, such as the Atoll radio frequency planning and optimization software, commercially available from Forsk S.A. S., Blagnac, France.

In at least some embodiments, the precheck and/or integration stability module 247 is configured to identify precheck activities as may be required pre-launch. For example, one or more precheck activities may depend upon one or more of various factors, such as the nature of the project, the technology, a system into which the project is integrating and/or modifying equipment, and so on. In at least some embodiments, the precheck tasks are prescribed, e.g., as part of a statement of work. Alternatively, or in addition the precheck tasks may be identified according to best practices. In at least some embodiments, the precheck tasks may be identified, append to and/or otherwise a modified by one or more of the functional entities participating in the project. In at least some embodiments, the precheck tasks may be obtained by collaboration among two or more functional entities, and so on.

It is further envisioned that artificial intelligence (AI) and/or machine learning (ML) may be applied to one or more features and/or functions of the PIER processor 240. For example, AI and/or ML may be used to develop models adapted to facilitate projects and/or tasks based on prior observations, simulations, predictions and the like. In at least some embodiments, application of the AI/ML can be used to determine and/or otherwise enhance precheck tasks, an ordering of tasks and/or subtasks, identification of task result thresholds, and the like, to obtain a predetermined success criteria. Any suitable success criteria may be used, such as a probability of successful launch.

In at least some embodiments, the reporting module 248 is configured to generate, update, organize, catalog and/or otherwise disseminate reports related to a particular project, a particular task and/or group of tasks, a particular technology, a particular geographic location, a particular functional entity, and so on. In at least some embodiments, the reports follow a predetermined format. Alternatively, or in addition, the reports may be customizable by one or more of the functional entities.

In at least some embodiments, the communications management module 249 configured to enable, to facilitate, to organize, to summarize, to catalog and/or otherwise disseminate communications related to a particular project, task, group of tasks, a particular technology, a particular geographic location, a particular functional entity and so on. Communications can include any suitable format as may be used by the participating functional entities and/or as prescribed and/or otherwise agreed to by the functional entities, as required by a statement of work and/or specification, as imposed by a project plan, a project manager and/or overseer, and so on. Communications can be managed according to a communication mode, a content type, a recipient, a composer, and so on. Communication modes may include, without limitation, email communications, text messages, including rich text messages, instant messaging, chat, voice, e.g., voice over IP (VoIP), voice messaging, video, video messaging, and so on. Communication content type may include textual communications, voice communications, still image and/or video communications.

In at least some embodiments, the communication management module 249 may perform translations between different types and/or modes of communications. For example, the communication management module 249 may include one or more of a text-to-speech function, a text reader function, an optical character recognition function, a communication summarizer, and so on. In at least some embodiments, the communication management module 249 organizes communications according to one or more attributes.

In at least some embodiments, the PIER processor 240 includes an external communications module 243. The external communications module 243 may be configured to enable and/or otherwise facilitate communications between the PIER processor 240 and one or more external systems and/or devices. Communications can include, without limitation, network communications, e.g., packet switched communications, voice communications, e.g., VoIP and/or circuit switched voice communications. Network communications may include one or more of local area network communications, mobile network communications, wide area network communications, e.g., via the Internet and the like.

In at least some embodiments, the storage module 251 is configured to store information processed by the PIER processor 240 and/or otherwise related to activities related to projects and/or tasks processed by the PIER processor 240. Stored information may include identifying information, such as project identifiers, task identifiers, function entity identifiers, report identifiers, status identifiers, and the like. Alternatively, or in addition, stored information may include prepared reports, e.g., as prepared by the reporting module 248. In at least some embodiments, the stored information includes communications as managed by the communications management module 249. Other stored information may include system requirements, project requirements, milestones, results attributable to any of the foregoing, and so on. Without limitation, the information may be stored as reports, as files, as data structures, as HTML documents, as text, as audio, as video, and so on.

In at least some embodiments, the information may be stored locally, e.g., in, at and/or proximal to the PIER processor 240, e.g., in a local storage device, such as a hard drive, an optical drive, a flash drive. Alternatively, or in addition, the information may be stored remotely, e.g., on a network storage device, e.g., a network drive, a cloud storage resource, and the like. In at least some embodiments, at least some of the information may be stored in a database, e.g., to facilitate access and retrieval.

In at least some embodiments, the external communications management module 243 configured to facilitate communications between the PIER processor 240 and one or more other entities, such as any of the participating functional entities, project, task, group of tasks, a particular technology, a particular geographic location and so on. The communications may be organized according to threads and/or in a folder structure that in at least some embodiments preserves chronological order. Alternatively, or in addition, the communications management module 243 may summarize and/or categories.

In at least some embodiments, the rules and/or policy module 242 is configured to implement one or more rules and/or policies. The rules and/or policies may be applied to any one or more of the various functions performed by the PIER processor 240, including any combination of the foregoing example functions. In at least some embodiments, the rules and/or policies may be imposed at a global level, e.g., across all activity of the PIER processor 240. Alternatively, or in addition, the rules and/or policies may be applied at any other level, such as project level, task level, report level, communication management level, and so on.

In At least some embodiments, the PIER processor 240 includes a user interface 250. The user interface 250 may be adapted to accept input from a user as may be provided in the form of inquiries, commands, and/or communications. Presentations of content may be organized as may be well suited for human consumption, for machine consumption, or for some combination of human and machine consumption. For example, reports generated by the reporting module 248 may be presented for display upon a display device, such as a dedicated display terminal, a remote user terminal and/or a mobile device screen. Accordingly, the reported information may be sized and/or organized for clarity, efficiency, and the like. In at least some embodiments, reported information may include embedded links and/or operable features, such as switches, buttons, pull-down displays, and the like.

FIG. 2D depicts an illustrative embodiment of a project integration evaluation report 260 in accordance with various aspects described herein. The report 260 may be prepared in such a manner as to support a textual and/or graphical representation, e.g., via a user interface as may be managed and/or otherwise supported by the user interface module 250. The example report is tabulated, but this is by no means a limitation. According to the example tabular report 260, information may be arranged according to one or more columns. Example columns may include, without limitation, one or more of a project reference 262a, a subsystem identifier 262b and/or a related technology 262c. Rows of the tabular report 260 may include entries under one or more of the provided columns, e.g., identifying one or more projects, one or more subsystems of a particular project, one or more technologies of a particular project and/or subsystem, and so on.

In at least embodiments, other columns may be included to capture a project requirement details, e.g., pre-launch and/or pre-check tasks 262d. Still other columns may allow for association of notes 262e, related communications 262f, participating entities 262g, and the like. At least some of the columns may include further details, such as an identification of a list or group of pre-launch and/or pre-check tasks. In at least some embodiments, each subtask entry may be portrayed along with a subtask status indicator 264a, e.g., pass, fail, not yet completed. Alternatively, or in addition, one or more of listed entries, such as notes may be presented with a selection button to permit a user to select an entry for further detail. Likewise, the communications may be identified according to groupings or threads, e.g., according to particular subtasks of the pre-launch and/or pre-check column 264d. Each communication grouping may be presented with a selection button 264c to permit selection of a communication member of the group or thread for expansion and/or further investigation.

In at least some embodiments, a list of participating functional entities 262g of a participants column may be presented with a selection button to permit a user to select one or more of the participating functional entities. In this instance, a selection may be made to identify an association of the report requester with one or more of the functional entities. In at least some embodiments at least some aspects of the report may be customized and/or otherwise configured according to an identity of the functional entity.

In at least some embodiments, the tabular report 260 may include status indicators. The status indicators may be detailed status indicators, e.g., as maybe presented in association with detailed tabular items, such as status of individual pre-launch and/or pre-check tasks. Alternatively, or in addition, the status indicators may include summary status indicators. According to the illustrative example, a first summary status indicator 266a is provided in the pre-launch and/or pre-check column 262d. For example, the first summary status indicator 266a may reflect a summary status of the individual task indicators. Alternatively, or in addition, the summary status indicator may reflect a summary status as determined according to a summary of the individual status indicators. It is envisioned that some individual status indicators may be weighted, e.g., with some being more important than others. Alternatively, or in addition, at least some of the individual summary indicators may controlling in at least some fashion, e.g., according to a green-yellow-red status indication, a green indicating “go” may not be issued if a status indicator identified as critical is not green or has not yet been evaluated yet. Other summaries may be obtained according to numerical averages, weighted averages of detailed indicators, and so on.

According to the illustrative example, the tabular report 260 includes a second summary status indicator 266b is provided in the notes column 262e and a third summary status indicator 266c is provided in the communications column 262f. The second summary status indicator 266b may be prepared to provide a summary of one or more notes and/or note threads. For example, a user may select an individual note and/or group of notes to be summarized. The PIER processor 240 may be configured to process the selected notes to obtain a summary. In at least some instances, the summaries may be prepared with the assistance of generative AI. Likewise, the third summary status indicator 266c may be prepared to provide a summary of one or more communications and/or communication threads of the communications column 262f. For example, a user may select an individual communication and/or group of communications to be summarized. The PIER processor 240 may be configured to process the selected communication items to obtain a summary. In at least some instances, the summaries may be prepared with the assistance of generative AI.

In at least some embodiments, the tabular report 260 may include an overall status column 262h. For example, the overall status column 363h may be configured to resent a status indicator 268 related to a pre-launch evaluation and/or test result. Depending upon a value and/or presentation of the status indicator 268, a quick determination may be made by simply inspecting the overall status field 262h. To the extent all prelaunch pre-check tasks have been completed to a predetermined level of satisfaction, the overall status indicator may be indicated according to a color scheme, e.g., green-yellow-red, a numeric value, e.g., a percentage, a graphical indicator, e.g., a thumbs up, or okay signal vs a thumbs down or halt indication and so on.

In at least some embodiments the particular columns and/or level of detail may be adjusted according to a user preference and/or an identified participant. For example, a vendor and/or engineer entity may be presented with a relatively detailed presentation of information, e.g., including a status of some or all subtasks, whereas, a project manager and/or overseer report may be primarily summary in nature, e.g., including summary status, without necessarily complicating the presentation of the tabular report 260 with details. Of course, the user may be provided with an option to select detail, to the extent such detail is available.

FIG. 2E is a block diagram illustrating an example, non-limiting embodiment of a project integration evaluation and reporting (PIER) system 270 functioning within the communication network of FIG. 1 in accordance with various aspects described herein. The example PIER system 270 includes a PIER processor 271 in communication with one or more user interfaces 274, site launching equipment 275, when provided (shown in phantom) and/or one or more other systems 276. Other systems 276 may include, without limitation, analysis systems, e.g., simulation systems, vendor systems, operation and maintenance systems, regulatory reporting systems, and so on. In at least some embodiments, the PIER processor 271 is in further communication with a storage device or system 272 as may be configured to store information related to one or more of supporting operation of the PIER processor 271, configuration information of the PIER processor 271, communications related to activities processed and/or otherwise managed by the PIER processor 271.

In at least some embodiments, the PIER processor 271 is in communication with one or more reports 273. For example, the reports may facilitate orchestration of project activities, organization of project activities, status of project activities and/or management of project activities. In at least some embodiments, at least some of the reports 273 and/or at least some portions of the reports 273, e.g., source content used in preparation of the reports may be retained in and/or obtained from the storage device or system 272.

According to the illustrative embodiment, the PIER processor 271 may be in communication with an AI and/or ML system 277. The AI/ML system 277 may be operable to develop and/or otherwise train, update, maintain and disseminate a model adapted to evaluate one or more activities related to the PIER processor 271. The model may include any model as may be adapted for use by the AI/ML system 277. In at least some embodiments, the model comprises a neural network. At least some neural networks may include internal nodes, e.g., referred to as deep neural networks.

The example PIER system 270 includes a training data repository 279 for storing training data as may be utilized in training a model to obtain a suitably trained model. In at least some instances, the training data includes associations of input and output values that may be fed into the model 278 to obtain results, which are then compared to the actual results to determine an error value. The error value may be used to adjust operation of the model to obtain an updated result having a reduced error. The process may continue until the error is below some tolerable error threshold.

Without limitation, the AI/ML system 227 may be used for one or more of any of the various modules of the PIER processor 271 disclosed herein. For example, the AI/ML system may be utilized to observe historical records of past projects to identify any patterns. Such observed patterns may be associated with positive performance indications, e.g., enhancing a project according to one or more of efficiency, cost savings, reliability, success criteria, and so on. The AI/ML system 227 may associate one or more contributing factors attributable to the improvements and/or enhancements. Accordingly, the AI/ML system 227 may provide recommendations for realizing similar improvements and/or enhancements in present and future tasks based on the prior observed patterns.

Similarly, such observed patterns may be associated with negative performance indications, e.g., as impair a project according to one or more of efficiency, cost expenditures, reliability, success criteria, and so on. The AI/ML system 227 may associate one or more contributing factors attributable to the impairments. Accordingly, the AI/ML system 227 may provide recommendations for realizing similar improvements and/or enhancements in present and future tasks based on the prior observed patterns. For example, the AI/ML system 227 may associate a particular vendor with impaired results for one type of project, while presenting enhanced performance for other projects. Accordingly, the AI/ML system 227 may recommend that the particular vendor be given those projects for which improvements would be likely, while preventing that vendor from being given those projects for which impairments are likely.

FIG. 2F depicts an illustrative embodiment of a project integration evaluation and reporting process 280 in accordance with various aspects described herein. According to the illustrative process, a site integration issue regarding integration of equipment into an existing and operational site is determined at 282. In at least some embodiments, the site installation issue is identified according to installation activity validation results. Results may be obtained responsive to a predetermined list of pre-check status checks and/or tests.

A remedial action is identified at 284 to address the identified site integration issue. In at least some embodiments, the remedial action may be identified by site integration personnel. Alternatively, or in addition, the remedial action may be determined in cooperation with a site integration engineer. Further according to the illustrative process 280, communications between responsible parties are expedited at 286 regarding identification of the issue, identification of the remedial action and updated status of the site integration process.

Beneficially, information related to the site integration is captured, organized and presented in a report at 288 that may be remotely accessible. In at least some embodiments, the report may track multiple integration projects for multiple sites, presenting the content in an easily accessible manner to facilitate tracking of individual site integration projects, status and related communications.

While for purposes of simplicity of explanation, the respective processes are shown and described as a series of blocks in FIGS. 2B and 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

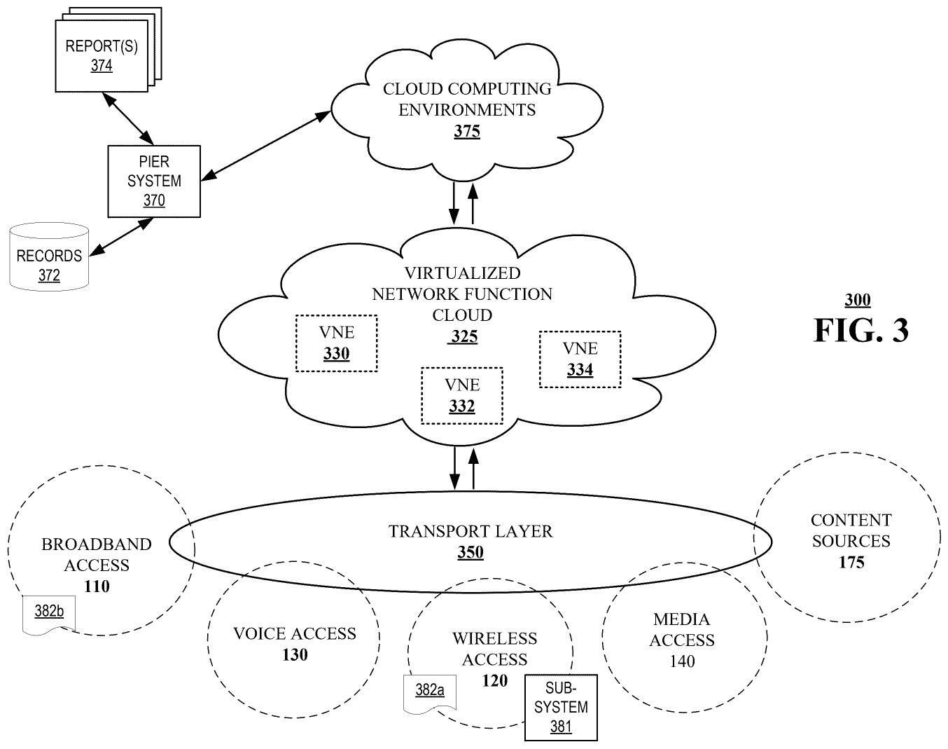

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of communication network 100, the subsystems and functions of systems 200. 240. 270, and processes 220, 280 presented in FIGS. 1, 2A, 2B, 2C, 2E, 2F and 3. For example, virtualized communication network 300 can facilitate in whole or in part determination of a site integration issue regarding integration of equipment into a remote site of an operational system, identification of a remediation action, which is sent to the site integrator to obtain updated installation activity validation results, which are incorporated into a remotely accessible report that facilitates tracking of issues, and remedies along with related communications in an efficient and organized manner.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc., that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc., to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc., can be instantiated and managed using an orchestration approach similar to those used in cloud compute services.

The cloud computing environments 375 can interface with the virtualized network function cloud 325 via APIs that expose functional capabilities of the VNEs 330, 332, 334, etc., to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

The virtualized communication network 300 includes project integration evaluation and reporting (PIER) system 370 configured to generate reports 374 and facilitate expedited and organized communication between site integration participants related to integration of equipment, e.g., the example subsystem 381, into a remote communications site. According to the illustrative embodiment, the PIER system 370 may be in communication with a storage device or system 372, which may be used to store the reports 374, communications, site specific information, e.g., site acceptance criteria, precheck tasks, and the like. In at least some embodiments, one or more of the mobile devices 324 and the data terminals 314 may be configured with an application program and/or portal to access a user interface 382a, 382b. The user interface 382a, 382b, generally 382, facilitates organization and reporting of activities related to integration of the subsystem 381.

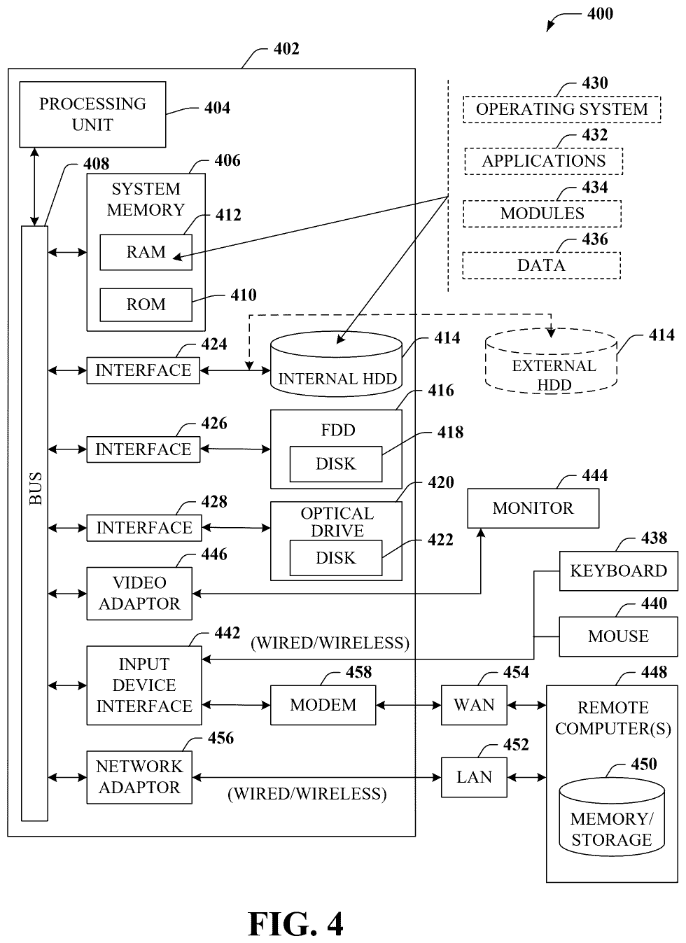

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part determination of a site integration issue regarding integration of equipment into a remote site of an operational system, identification of a remediation action, which is sent to the site integrator to obtain updated installation activity validation results, which are incorporated into a remotely accessible report that facilitates tracking of issues, and remedies along with related communications in an efficient and organized manner.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are examples and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

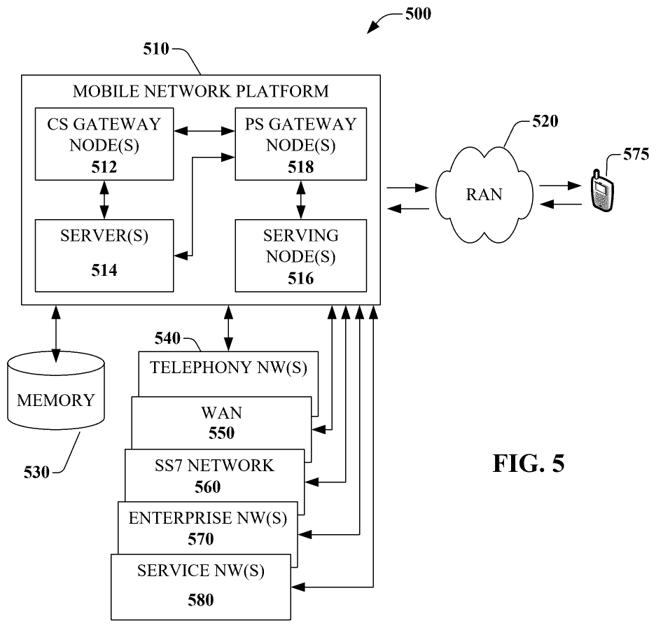

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part determination of a site integration issue regarding integration of equipment into a remote site of an operational system, identification of a remediation action, which is sent to the site integrator to obtain updated installation activity validation results, which are incorporated into a remotely accessible report that facilitates tracking of issues, and remedies along with related communications in an efficient and organized manner. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules.

Generally, program modules comprise routines, programs, components, data structures, etc., that perform particular tasks and/or implement particular abstract data types.

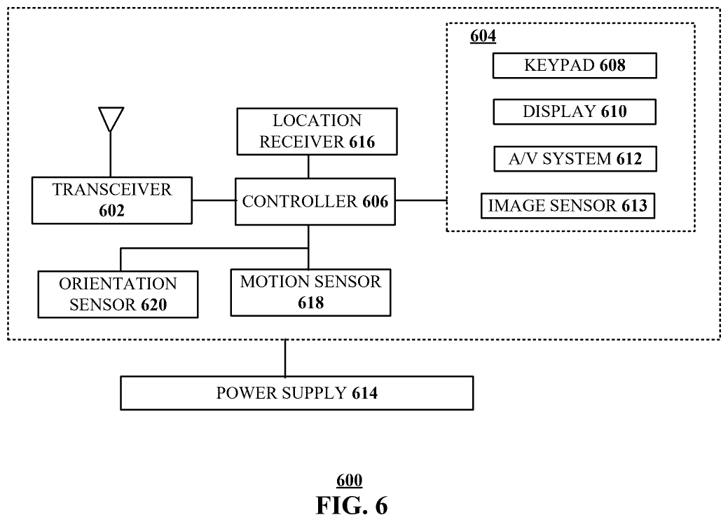

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part determination of a site integration issue regarding integration of equipment into a remote site of an operational system, identification of a remediation action, which is sent to the site integrator to obtain updated installation activity validation results, which are incorporated into a remotely accessible report that facilitates tracking of issues, and remedies along with related communications in an efficient and organized manner.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof.

Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x) =confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed.

Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
receiving, by a processing system including a processor, a plurality of installation activity validation results obtained from site integration equipment of a site integrator regarding integration of equipment into a remote site of a geographically dispersed operational system;
identifying, by the processing system, a site integration issue regarding integration of the equipment into the remote site based on the plurality of installation activity validation results;
transmitting, by the processing system and responsive to the identifying the site integration issue, a first communication to equipment of an engineer reporting the site integration issue for the remote site;
receiving, by the processing system, a second communication from the equipment of the engineer identifying a remediation action regarding the site integration issue for the remote site;
receiving, by the processing system, t a third communication comprising a plurality of updated installation activity validation results reflecting implementation of the remediation action at the remote site; and
organizing, by the processing system and within a report, the first, second and third communications in association with an indication of at least one of the remote site, the site integrator or the engineer, to obtain organized communications, wherein the report is remotely accessible.

2. The method of claim 1, wherein the identifying the site integration issue further comprises:
comparing, by the processing system, a specified installation parameter to a measured installation parameter.

3. The method of claim 1, further comprising:
determining, by the processing system, an acceptance criteria indicating the integration of the equipment into the remote site is ready to launch into the geographically dispersed operational system.

4. The method of claim 1, wherein the report facilitates remote access to the organized communications.

5. The method of claim 1, further comprising:
generating, by the processing system, a status indicator regarding the integration of equipment at the remote site, based on the plurality of installation activity validation results, wherein the status indicator indicates an acceptance status regarding the integration of the equipment at the remote site.

6. The method of claim 5, further comprising:
updating, by the processing system, the status indicator to obtain an updated status indicator based on the plurality of updated installation activity validation results, wherein the updated status indicator indicates an updated acceptance status regarding the integration of the equipment at the remote site.

7. The method of claim 1, further comprising:
organizing, by the processing system, the plurality of updated installation activity validation results to obtain organized updated installation activity validation results; and
updating, by the processing system, the report based on the organized updated installation activity validation results.

8. The method of claim 1, further comprising:
providing, by the processing system, a graphic user interface, wherein the report is remotely accessible via the graphic user interface.

9. The method of claim 8, wherein the first, second and third communications are initiated via the graphic user interface.

10. A non-transitory, machine-readable medium, comprising executable instructions that, when executed by a processing system including a processor, facilitate performance of operations, the operations comprising:
obtaining a plurality of installation activity validation results obtained from site integration equipment of a site integrator regarding integration of equipment into a remote site of a geographically dispersed operational system;
determining a site integration issue regarding integration of the equipment into the remote site based on the plurality of installation activity validation results;
sending, responsive to the determining the site integration issue, a first communication to equipment of an engineer reporting the site integration issue for the remote site;
obtaining a second communication from the equipment of the engineer identifying a remediation action regarding the site integration issue for the remote site;
receiving a third communication from the equipment of the site integrator, wherein the third communication comprises a plurality of updated installation activity validation results obtained responsive to implementation of the remediation action at the remote site r; and
organizing within a report the first, second and third communications in association with an indication of at least one of the remote site, the site integrator or the engineer, to obtain organized communications, wherein the report is remotely accessible.

11. The non-transitory, machine-readable medium of claim 10, further comprising:
generating a status indicator regarding the integration of equipment at the remote site, based on the plurality of installation activity validation results, wherein the status indicator indicates an acceptance status regarding the integration of the equipment at the remote site.

12. The non-transitory, machine-readable medium of claim 11, further comprising:
updating the status indicator to obtain an updated status indicator based on the plurality of updated installation activity validation results, wherein the updated status indicator indicates an updated acceptance status regarding the integration of the equipment at the remote site.

13. The non-transitory, machine-readable medium of claim 10, further comprising:
organizing the plurality of updated installation activity validation results to obtain organized status indicator results; and
updating the report based on the organized status indicator results.

14. The non-transitory, machine-readable medium of claim 10, further comprise:
generating an alarm based on the plurality of installation activity validation results, wherein the sending the first communication is responsive to the alarm.

15. The non-transitory, machine-readable medium of claim 10, wherein the geographically dispersed operational system comprises a communication network, and wherein the integration of the equipment comprises integrating base station equipment into a base station of a mobile segment of the communications network.

16. A system, comprising:
a processing system including a processor; and
a memory that stores executable instructions that, when executed by the processing system, facilitate performance of operations, the operations comprising:
determining a site integration issue regarding integration of equipment into a remote site based on a plurality of installation activity validation results obtained from site integration equipment of a site integrator regarding integration of equipment into a remote site of a geographically dispersed operational system;
determining a remediation action regarding the site integration issue for the remote site;
obtaining a plurality of updated installation activity validation results responsive to implementation of the remediation action at the remote site; and
organizing within a report the plurality of installation activity validation results, the indication of the remediation action and the plurality of updated installation validation activity results.

17. The system of claim 16, wherein the operations further comprise:
identifying responsible entities regarding the site integration issue and the remediation action; and
facilitating a direct communication to equipment of the responsible entities regarding the site integration issue and the remediation action.

18. The system of claim 17, wherein the responsible entities comprise the site integrator, an engineer and a project manager.

19. The system of claim 17 wherein the operations further comprise:
generating an alarm based on the plurality of installation activity validation results, wherein the direct communication is responsive to the alarm.

20. The system of claim 16, wherein the operations further comprise:
generating a progress indicator based on the plurality of installation activity validation results;
updating the progress indicator to obtain an updated progress indicator based on the plurality of updated installation activity validation results; and
presenting the updated progress indicator in the report.
